(19) United States
(12) Patent Application Publication
(10) Pub. No.: US 2018/0207043 A1
(43) Pub. Date: Jul. 26, 2018

(54) Chiropractic Table Headpiece

(71) Applicant: Joshua Silver, St. Petersburg, FL (US)

(72) Inventor: Joshua Silver, St. Petersburg, FL (US)

(21) Appl. No.: 15/880,017

(22) Filed: Jan. 25, 2018

Related U.S. Application Data
(60) Provisional application No. 62/450,477, filed on Jan. 25, 2017.

(51) Int. Cl. A61G 13/00

(52) U.S. Cl. CPC A61G 13/009; A61H 1/008

(57) ABSTRACT

The chiropractic table headpiece is an apparatus that tilts the neck and head of a patient and secures the orientation of the head. The apparatus includes a base plate, an upper elongated headrest, a lower elongated headrest, at least one first track, and at least one second track. The base plate upholds the upper elongated headrest and the lower elongated headrest. The upper elongated headrest and the lower elongated headrest support and guide the head of the patient. The lower elongated headrest includes a central groove which accommodates an ear of the patient. The at least one first track and the at least one second track direct and guide the upper elongated headrest and the lower elongated headrest, respectively. The apparatus further includes a propping arm, a hinge adapter, a first lateral arm, and a second a lateral arm in order to mount the base plate to a chiropractic table.

The current application claims a priority to the U.S. Provisional Patent application Ser. No. 62/450,477 filed on Jan. 25, 2017.

### FIELD OF THE INVENTION

The present invention generally relates to chiropractic table accessories. More specifically, the present invention is a universal chiropractic table headpiece that comfortably positions and securely orients the head of a patient who is resting on a chiropractic table.

### BACKGROUND OF THE INVENTION

Chiropractic has been a recognized profession in America since 1895, known for treating misalignments in the spine and various musculoskeletal diseases. A specialized field of study in the upper cervical spine has developed due to a unique joint structure and proximity to the brain. The cranio-cervical junctions have been regarded as a potential site for generating headaches, neck pain, and traumas to the areas that are often overlooked. This anatomical region has led to the development of several adjusting procedures that focus on restoring the occiput, atlas, and axis into orthogonal alignment. Of these procedures exist the National Upper Cervical Chiropractic (NUCCA) procedure, the Knee Chest Upper Cervical Adjustment, the Blair Upper Cervical Chiropractic Technique, and Toggle Recoil Adjustment, all of which are adjustments delivered by hand.

In 1985, Roy Sweat developed the first Atlas Orthogonal Instrument which delivered a precise thrust to the upper cervical region, thus reducing the amount of human error in the adjustment. The technique later moved the administration of force from a protruding stylus into a vectored percussive wave. The angle of correction is determined from 4 X-rays of the head, each of which measure lateral and rotational movements of the atlas under the occiput and C2 rotation below the atlas. In 2001, Advanced Orthogonal grew out of its predecessor Atlas Orthogonal, adding several unique table modifications and X-ray measurements which ultimately improved quality of the adjustment.

Currently in the technique, there is a headpiece that a patient rests his or her skull on when delivering the adjustment. The traditional headpiece stabilizes the skull during the adjustment to prevent rocking of the head and interference in the adjustment.

Although the current headpiece has been effective in doing so, the current headpiece has several flaws. The entire weight of the head must be placed on the tip of the mastoid bone, which is often very uncomfortable to the patient. This arrangement results in spasms in the neck of the patient which greatly interferes with the adjustment procedure. Often, the correct positioning of the head of the patient on the headpiece is difficult and time consuming for the chiropractor. A degree measurement chart is used for measuring the X-axis rotation of the skull, but is not calibrated accurately. Most importantly, the current headpiece does not allow the chiropractor to freely influence head rotation around the Z-axis and Y-axis which is an important part in the correction.

It is an object of the present invention to provide an improved support to the Advanced Orthogonal adjusting instrument which will lead to more accurate positioning the patients head when delivering the adjustment. It is another object of the present invention to provide a headpiece which allows for improved patient comfort during the adjustment to allow for better health outcomes. Furthermore, another object of the present invention is to provide easier and faster placement of the patient on the headpiece with complete stability.

### BRIEF DESCRIPTION OF THE DRAWINGS

FIG. 1 is a perspective view of the of the present invention.

FIG. 2 is a top side view of the present invention.

FIG. 3 is a cross-section view of the FIG. 2 along line 3-3 of the present invention.

FIG. 4 is a cross-section view of the FIG. 2 along line 4-4 of the present invention.

FIG. 5 is a top side view of the present invention with the upper elongated headrest retracted towards the support plate and the lower elongated headrest positioned adjacent to the left arm-attachment tab.

FIG. 6 is a bottom side view of the present invention.

FIG. 7 is a perspective view of the preferred embodiment of the present invention with the first lateral arm and the second lateral arm connected to the left-arm attachment tab and the right-arm attachment tab, respectively.

FIG. 8 is a perspective view of the preferred embodiment of the present invention with the base plate rotated with the hinged connection between first lateral arm and the second lateral arm and the left-arm attachment tab and the right-arm attachment tab, respectively.

### DETAIL DESCRIPTIONS OF THE INVENTION

All illustrations of the drawings are for the purpose of describing selected versions of the present invention and are not intended to limit the scope of the present invention.

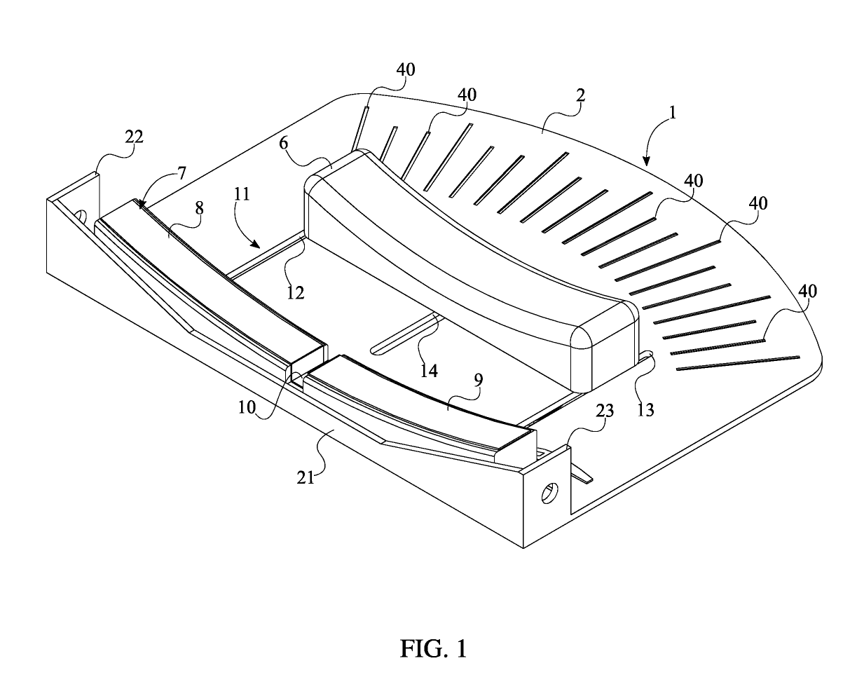

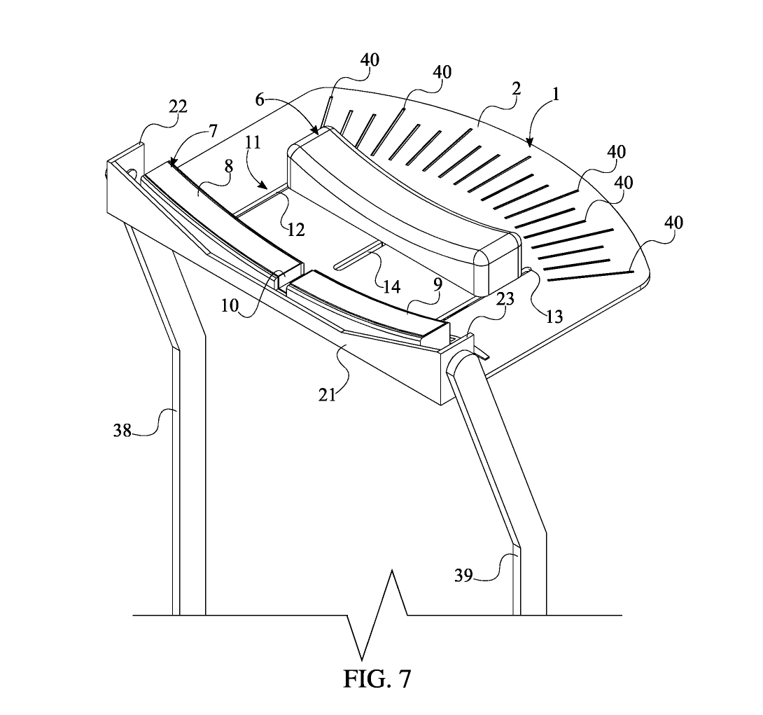

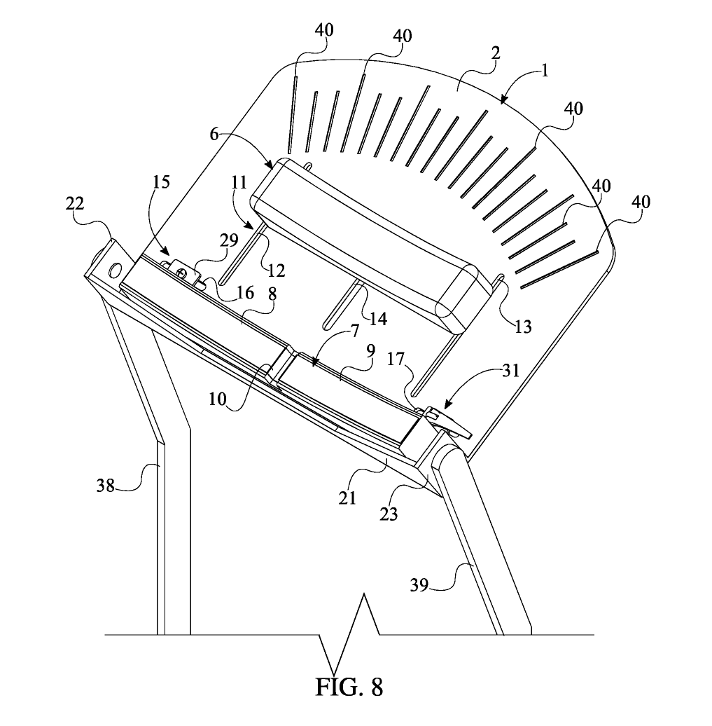

The present invention is a chiropractic table headpiece that guides and supports the head of a patient. More specifically, the present invention maintains the desired position of the neck and the head of the patient. The present invention serves as a universal attachment for chiropractic tables. As seen in FIG. 1, FIG. 7, and FIG. 8, the present invention comprises a base plate 1, an upper elongated headrest 6, a lower elongated headrest 7, at least one first track 11, and at least one second track 15. The base plate 1 upholds the upper elongated headrest 6 and the lower elongated headrest 7. The upper elongated headrest 6 and the elongated headrest position and tilt the neck and the head of the patient, while effectively supporting the head of the patient. More specifically, the upper elongated headrest 6 supports the parietal bone and the lower elongated headrest 7 supports the mastoid bone. The at least one first track 11 allows the upper elongated headrest 6 to traverse along the base plate 1. Similarly, the at least one second track 15 allows the lower elongated headrest 7 to traverse along the base plate 1. The position of the upper elongated headrest 6 and the position of the lower elongated headrest 7 with respect to each other allows the neck and head of the patient to be oriented at a desired angle. In the preferred embodiment of the present invention, the upper elongated headrest 6 and the lower elongated headrest 7 both comprise an ergonomic structure that accommodates the contours of a head 35. Furthermore, the upper elongated headrest 6 and the lower elongated headrest 7, preferably, each comprise a cushioned layer along the surfaces that contact the head of the patient.

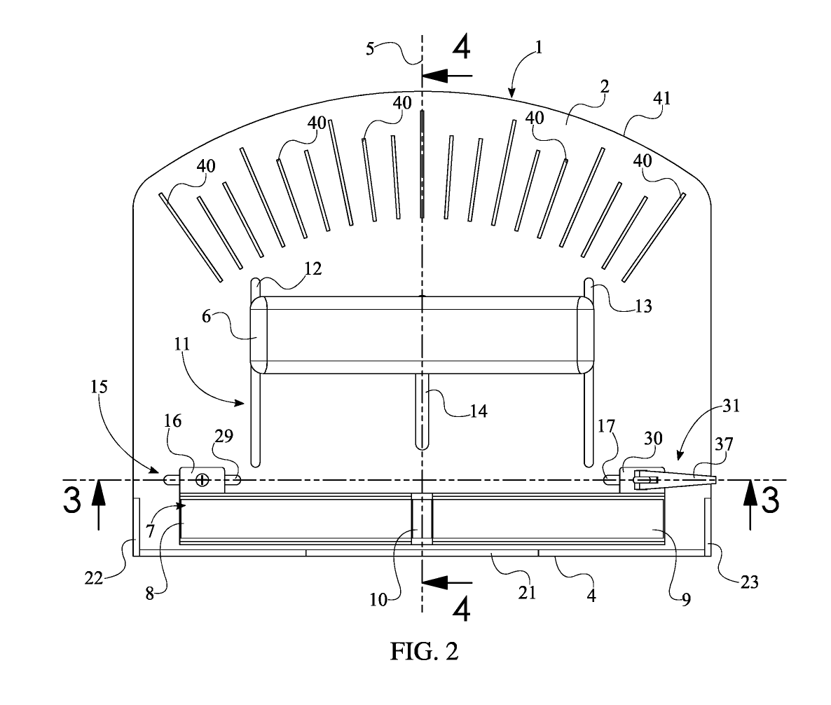

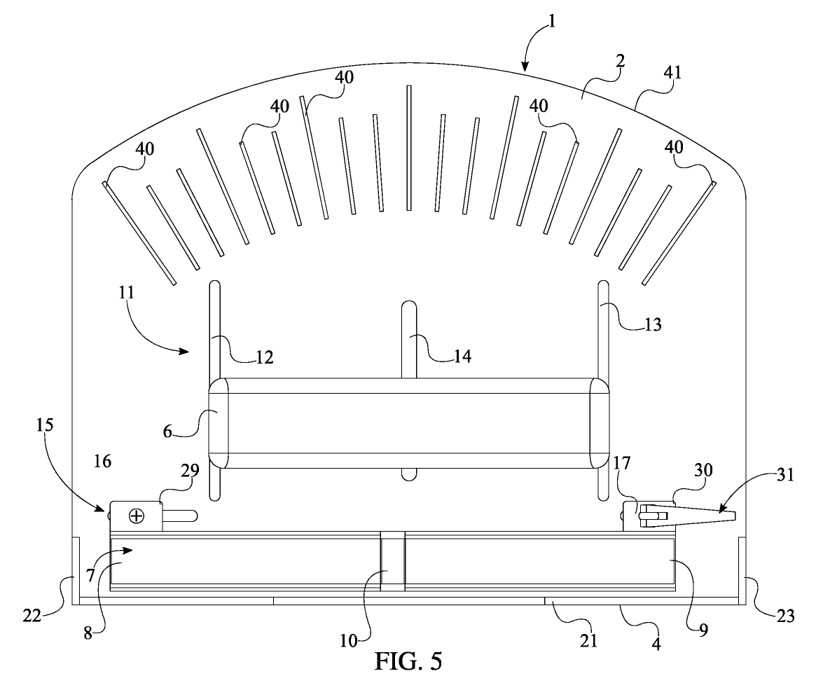

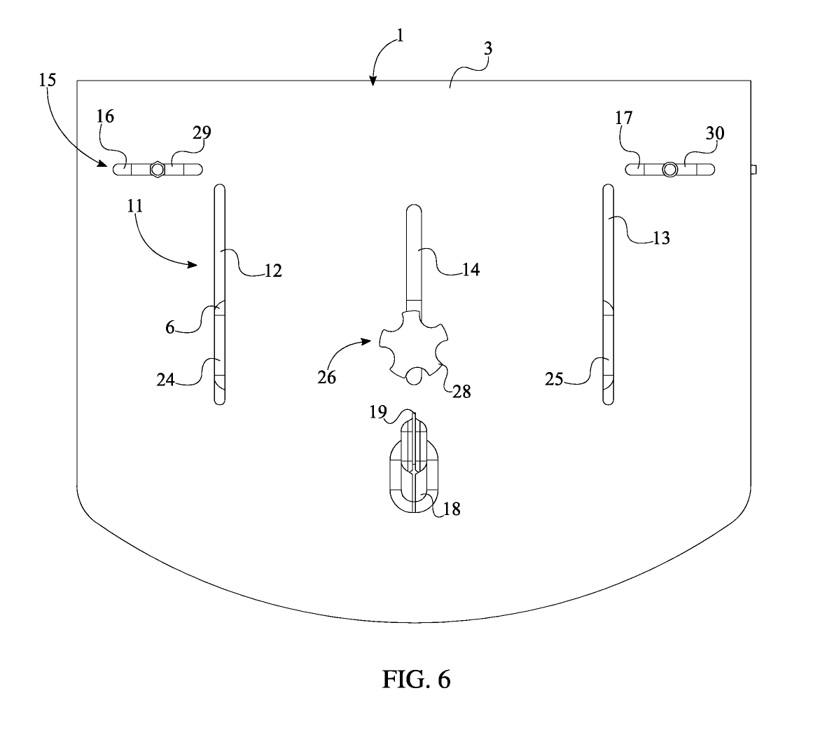

The overall configuration of the aforementioned components allows the neck and the head of a patient who is resting on chiropractic table to be properly oriented. As seen in FIG. 5 and FIG. 6, the at least one first track 11 and the at least one second track 15 traverse through the base plate 1, allowing upper elongated headrest 6 and the lower elongated headrest 7, respectively, to connect with the base plate 1. More specifically, the height of the heads of varying patients is accommodated as the at least one first track 11 and the at least one second track 15 are oriented perpendicular to each other. The at least one second track 15 is positioned adjacent and parallel to a proximal straight edge 4 of the base plate 1 in order to tilt the neck and head of the patient. The neck and the head of the patient are tilted as the upper elongated headrest 6 is slidably mounted along the at least one first track 11, as shown in FIG. 2 and FIG. 5. Similarly, the lower elongated headrest 7 is slidably mounted along the at least one second track 15, also as shown in FIG. 2 and FIG. 5. The upper elongated headrest 6 and the lower elongated headrest 7 contact the head of the patient as the upper elongated headrest 6 and the lower elongated headrest 7 are positioned adjacent a first surface 2 of the base plate 1, the first surface 2 being oriented towards the head of the patient. Furthermore, the upper elongated headrest 6 and the lower elongated headrest 7 accommodate the overall structure of the head of the patient, as the upper elongated headrest 6 and the lower elongated headrest 7 are oriented parallel to each other.

Not only does the upper elongated headrest 6 and the lower elongated headrest 7 support the head of the patient, but comforts the head of the patient as the patient rests on the present invention. The present invention further accommodates the structure of the head 35 as the lower elongated headrest 7 comprises a left brace 8, a right brace 9, and a central groove 10, seen in FIG. 1, FIG. 2, FIG. 5, FIG. 7, and FIG. 8. The left brace 8 supports and upholds the right side of the mastoid bone, and the right brace 9 supports and upholds the left side of the mastoid bone. The central groove 10 allows the corresponding ear of the user to suspend between the left brace 8 and the right brace 9, thereby eliminating any pressure of force against the corresponding ear of the user. The left brace 8 and the right brace 9 are positioned opposite each other along the lower elongated headrest 7 to mirror the right side and left side of the mastoid bone, respectively. The central groove 10 laterally traverses into the elongated headrest in between the left brace 8 and the right brace 9 to accommodate the position of an ear of the user with respect to both the right side and the left side of the mastoid bone.

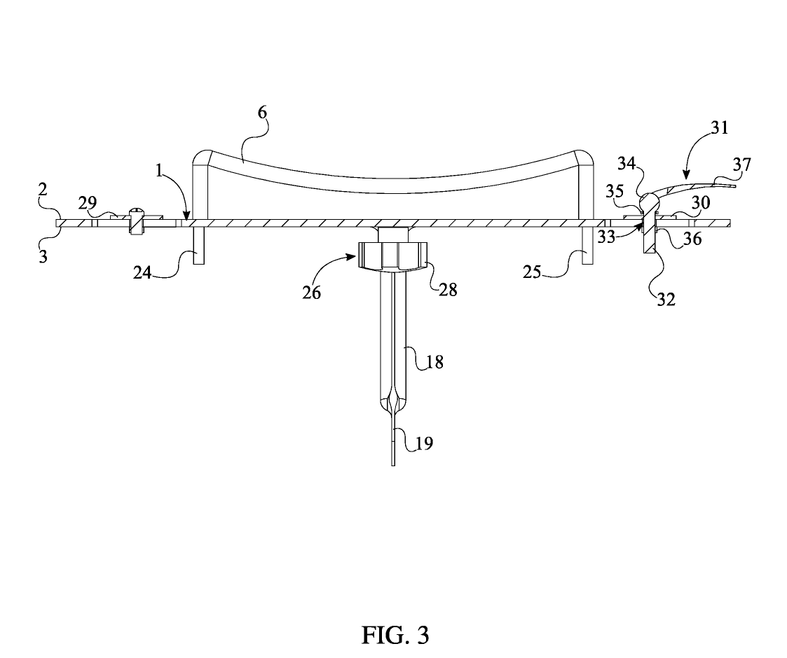

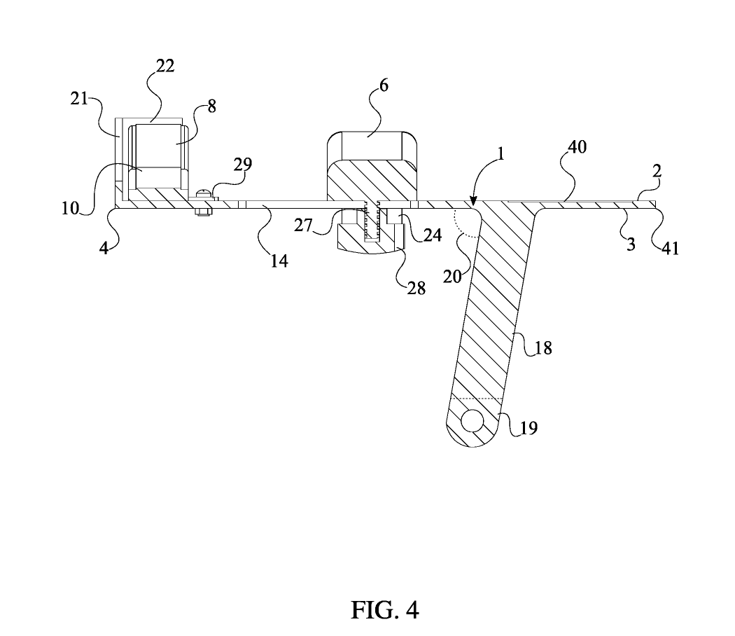

The present invention serves as a universal attachment to chiropractic tables, and more specifically the hydraulic system of chiropractic tables as present invention further comprises a propping arm 18 and a hinge adaper 19, shown in FIG. 3 and FIG. 4. The propping arm 18 distances the base plate 1 from the hinge adaper 19 which connects the present invention to a hydraulic pump of a corresponding chiropractic table. More specifically, the hinge adaper 19 connects to the hydraulic pump that tilts the base plate 1 upwards and downwards. The hydraulic pump of the chiropractic table preferably comprises three switches that are mounted to the base plate 1. The three switches of the hydraulic pump tilt the base plate 1 upwards and downwards, to the left, and to the right. The hinge adaper 19 preferably corresponds to the switch and the hydraulic pump that tilts the base plate 1 upwards and downwards. Furthermore, the propping arm 18 upholds the base plate 1 and structurally supports the weight of the base plate 1, the upper elongated headrest 6, the lower elongated headrest 7, and the head of the patient. In order to effectively uphold the base plate 1 without disturbing the path of the upper elongated headrest 6 and the lower elongated headrest 7, a second surface 3 of the base plate 1 is terminally connected to the propping arm 18. The second surface 3 of the base plate 1 is oriented away from the head of the patient and is opposite the first surface 2 of the base plate 1. In order to connect to the hydraulic pump of the chiropractic table, the hinged adapter is terminally connected to the propping arm 18, opposite the second surface 3 of the base plate 1. In the preferred embodiment of the present invention, the propping arm 18 and the second surface 3 of the base plate 1 are oriented at an acute angle 20 with each other, effectively supporting the weight of the base plate 1, the upper elongated headrest 6, the lower elongated headrest 7, and the head of the patient, while orienting the base plate 1 at the correct angle.

As illustrated in FIG. 1, FIG. 2, FIG. 5, FIG. 7, and FIG. 8, the present invention further comprises a support plate 21 to support the weight of the head of the patient and the base plate 1 is tilted upwards and downwards. The support plate 21 is positioned adjacent and along the proximal straight edge 4 of the base plate 1 so the majority of the weight of the head 35 is oriented towards the proximal straight edge 4 of the base plate 1. More specifically, the support plate 21 is connected perpendicular to the first surface 2 of the base plate 1, thereby maximizing the support for the head of the patient. The present invention further comprises a left arm-attachment tab 22 and a right-arm attachment tab 23, also seen in FIG. 1, FIG. 2, FIG. 5, FIG. 7, and FIG. 8 The left arm-attachment tab 22 and the right arm-attachment tab 23 allows the base plate 1 be mounted to a chiropractic table while rotating about a rotation axis. The rotation of the base plate 1 about the rotation axis while allows the base plate 1 to be tilted upwards and downwards. The rotation axis traverses through the left arm-attachment tab 22 and the right arm-attachment tab 23. The left arm-attachment tab 22 is terminally positioned to the proximal straight edge 4 of the base plate 1. Similarly, the right arm-attachment tab 23 is terminally positioned to the proximal straight edge 4 of the base plate 1, opposite the left arm-attachment tab 22. The offset arrangement of the left arm-attachment tab 22 and the right arm-attachment tab 23 maximizes the structurally integrity of the present invention while being mounted onto a chiropractic table. Preferably, the left arm-attachment tab 22 is connected perpendicular to the first surface 2 of the base plate 1, and the right arm-attachment is connected perpendicular to the first surface 2 of the base plate 1, thereby minimizing the force of the weight of the head 35 against the base plate 1.

The preferred embodiment of the present invention further comprises a first lateral arm 38 and a second lateral arm 39 in order to mount the base plate 1 to the chiropractic table, seen in FIG. 7 and FIG. 8. More specifically, the first lateral arm 38 and the second lateral arm 39 upholds the base plate 1 above the chiropractic table. The base plate 1 is able to be tilted upwards and downwards while being mounted to the chiropractic table as the first lateral arm 38 is rotatably connected to the left arm-attachment tab 22. Similarly, the second lateral arm 39 is rotatably connected to the right arm-attachment tab 23. The first lateral arm 38 and the second lateral arm 39 are oriented away from the first surface 2 of the base plate 1 so that the head of the patient may contact the upper elongated headrest 6 and the lower elongated headrest 7.

In order for the upper elongated headrest 6 to smoothly traverse along the at least one first track 11, the present invention comprises a left insert 24 and a right insert 25, as shown in FIG. 3 and FIG. 6. Furthermore, the at least one left track comprises a left vertical track 12 and a right vertical track 13. The left vertical track 12 and the right vertical track 13 accommodate the left insert 24 and the right insert 25, respectively. The left vertical track 12 and the right vertical track 13 are positioned offset and parallel to each other and is positioned opposite to each other along the upper elongated headrest 6.

This arrangement structurally supports the upper elongated headrest 6 as the upper elongated headrest 6 traverses along the base plate 1. More specifically, the left insert 24 is slidably engaged along the left vertical track 12. Similarly, the right insert 25 is slidably engaged along the right vertical track 13.

Upon the desired position of the upper elongated headrest 6 along the at least one first track 11, the present invention comprises a first lock 26, illustrated in FIG. 3, FIG. 4, and FIG. 6. The at least one first track 11 comprises a locking track 14 in order to accommodate the first lock 26. More specifically, the first lock 26 comprises a male-threaded shaft 27 and a female threaded knob. The male threaded shaft 32 allows the upper elongated headrest 6 to connect with the base plate 1 through the locking track 14. The female-threaded knob 28 secures position of the upper elongated headrest 6 along the locking track 14. The locking track 14 is centrally aligned along the proximal straight edge 4 of the base plate 1 in order to accommodate the structure of the head 35 and properly position the head of the patient along the base plate 1. The upper elongated headrest 6 is able to connect to the base plate 1 through the locking track 14 as the male-threaded shaft 27 is laterally connected to the upper elongated headrest 6. The male-threaded shaft 27 is centrally aligned along the upper elongated headrest 6 in order to centrally align the upper elongated headrest 6 with the base plate 1. The position of the upper elongated headrest 6 along the at least first track is securable as the male-threaded shaft 27 traverses through the locking track 14, and the female-threaded knob 28 is engaged by the male-threaded shaft 27, opposite the upper elongated headrest 6.

In order for the lower elongated headrest 7 to traverse along the at least one second track 15, the present invention comprises a first tab 29 and a second tab 30, seen in FIG. 2 and FIG. 5. Furthermore, the at least one second track 15 comprises a left horizontal track 16 and a right horizontal track 17. The left horizontal track 16 and the right horizontal track 17 accommodate the first tab 29 and the second tab 30, respectively. The left horizontal track 16 and the right horizontal track 17 are positioned offset and colinear to each other. This arrangement facilitates the linear movement of the lower elongated track along the at least one second track 15 while supporting the weight of the head of the patient. In order for the first tab 29 and the second tab 30 to engage with the left horizontal track 16 and the right horizontal track 17, respectively, while supporting the lower elongated headrest 7, the first tab 29 and the second tab 30 is laterally connected to the lower elongated headrest 7. More specifically, the first tab 29 and the second tab 30 are positioned opposite to each other along the lower elongated headrest 7. The first tab 29 and the second tab 30 are preferably positioned parallel to the base plate 1 to acuratley angle the neck and the head of the patient while on the corresponding chirpractic table. The first tab 29 is slidably mounted along the horizontal track. Similarly, the second tab 30 is slidably mounted along the right horizontal track 17.

Upon the desired position of the lower elongated headrest 7 along the at least one second track 15, the present invention comprises a second lock 31, seen in FIG. 2, FIG. 3, FIG. 5, and FIG. 6. More specifically, the second lock 31 comprises a shaft 32, a lock-receiving hole 33, a clevis 34, a head 35, a stopper 36, and a cam-locking handle 37. The shaft 32 allows the second lock 31 to connect to the second tab 30 and the base plate 1. The lock-receiving hole 33 allows the shaft 32 to traverse through the second tab 30. The clevis 34 connects the cam-locking handle 37 to the shaft 32 and allows the cam-locking handle 37 to rotate. The head 35 and the stopper 36 both clamp the second tab 30 to the base plate 1 with the rotation of the cam-locking handle 37 and, consequently, secure the position of the lower elongated headrest 7 along the at least one second track 15. In order for the head 35 and the stopper 36 to effectively clamp against the second tab 30 and the base plate 1, the lock-receiving hole 33 traverses normal through the second tab 30. The shaft 32 is slidably engaged through the lock-receiving hole 33 and through the right horizontal track 17, thereby allowing the lower elongated shaft 32 to freely traverse along the at least one second track 15. In the preferred embodiment of the present invention, the head 35 is positioned adjacent the second surface 3 of the base plate 1, and the stopper 36 is positioned adjacent to the second tab 30. More specifically, the head 35 is terminally connected to the shaft 32, and the stopper 36 is slidably connected along the shaft 32, offset from the head 35. This arrangement minimizes the force required to clamp the base plate 1 and the second tab 30 with the cam-locking handle 37. Moreover, the cam-locking handle 37 is terminally and pivotally connected to the shaft 32, opposite the head 35, allowing t second tab 30 and the base plate 1 to be fastened with and released from each other.

The preferred embodiment of the present invention further comprises a plurality of degree markers 40, illustrated in FIG. 1, FIG. 2, FIG. 4, FIG. 5, FIG. 7, and FIG. 8. The plurality of degree markers 40 indicates the angle of rotation of the tilt of the neck and the head 35. The plurality of degree markers 40 is inscribed into the first surface 2 of the base plate 1 as the head of the patient rests on the upper elongated headrest 6 and the lower elongated headrest 7. The plurality of degree markers 40 is positioned opposite the lower elongated headrest 7. More specifically, the plurality of degree markers 40 is radially distributed about a curved distal edge 41 of the base plate 1 and is centrally aligned with a sagittal plane 5 of the base plate 1. This allows the tilt of the neck and head of the patient to be accurately referenced.

Although the invention has been explained in relation to its preferred embodiment, it is to be understood that many other possible modifications and variations can be made without departing from the spirit and scope of the invention as hereinafter claimed.

What is claimed is:

1. A chiropractic table headpiece comprises:
a base plate;
an upper elongated headrest;
a lower elongated headrest;
at least one first track;
at least one second track;
the at least one first track and the at least one second track traversing through the base plate;
the at least one first track and the at the least one second track being oriented perpendicular to each other;
the at least one second track being positioned adjacent and parallel to a proximal straight edge of the base plate;
the upper elongated headrest being slidably mounted along the at least first track;
the lower elongated headrest being slidably mounted along the at least one second track;
the upper elongated headrest and the lower elongated headrest being positioned adjacent a first surface of the base plate; and,
the upper elongated headrest and the lower elongated headrest being oriented parallel to each other.

2. The chiropractic table headpiece as claimed in claim 1 comprises:
the lower elongated headrest comprises a left brace, a right brace, and a central groove;
the left brace and the right brace being positioned opposite each other along the lower elongated headrest; and,
the central groove laterally traversing into the lower elongated headrest in between the left brace and the right brace.

3. The chiropractic table headpiece as claimed in claim 1 comprises:
a propping arm;
a hinge adapter;
a second surface of the base plate being terminally connected to the propping arm;
the hinged adapter being terminally connected to the propping arm, opposite the second surface of the base plate; and,
the propping arm and the second surface of the base plate being oriented at an acute angle with each other.

4. The chiropractic table headpiece as claimed in claim 1 comprises:
a support plate;
the support plate being positioned adjacent and along the proximal straight edge of the base plate; and,
the support plate being connected perpendicular to the first surface of the base plate.

5. The chiropractic table headpiece as claimed in claim 1 comprises:
a left arm-attachment tab;
a right arm-attachment tab;
the left arm-attachment tab being terminally positioned to the proximal straight edge of the base plate;
the right arm-attachment tab being terminally positioned to the proximal straight edge of the base plate, opposite the left arm-attachment tab;
the left arm-attachment tab being connected perpendicular to the first surface of the base plate; and,
the right arm-attachment tab being connected perpendicular to the first surface of the base plate.

6. The chiropractic table headpiece as claimed in claim 5 comprises:
a first lateral arm;
a second lateral arm;
the first lateral arm being rotatably connected to the left arm-attachment tab;
the second lateral arm being rotatably connected to the right arm-attachment tab; and,
the first lateral arm and the second lateral arm being oriented away from the first surface of the base plate.

7. The chiropractic table headpiece as claimed in claim 1 comprises:
a left insert;
a right insert;
the at least one left track comprises a left vertical track and a right vertical track;
the left vertical track and the right vertical track being positioned offset and parallel to each other;
the left insert and the right insert being laterally connected to the upper elongated headrest;
the left insert and the right insert being positioned opposite to each other along the upper elongated headrest;
the left insert being slidably engaged along the left vertical track; and,
the right insert being slidably engaged along the right vertical track.

8. The chiropractic table headpiece as claimed in claim 1 comprises:
a first lock;
the first lock comprises a male-threaded shaft and a female-threaded knob;
the at least one first track comprises a locking track;
the locking track being centrally aligned along the proximal straight edge of the base plate;
the male-threaded shaft being laterally connected to the upper elongated headrest;
the male-threaded shaft being centrally aligned along the elongated headrest;
the male-threaded shaft traversing through the locking track; and,
the female-threaded knob being engaged by the male-threaded shaft, opposite the upper elongated headrest.

9. The chiropractic table headpiece as claimed in claim 1 comprises:
a first tab;
a second tab;
the at least one second track comprises a left horizontal track and a right horizontal track;
the left horizontal track and the right horizontal track being positioned offset and colinear to each other;
the first tab and the second tab being laterally connected to the lower elongated headrest;
the first tab and the second tab being positioned opposite to each other along the lower elongated headrest;
the first tab and the second tab being positioned parallel to the base plate;
the first tab being slidably mounted along the left horizontal track; and,
the second tab being slidably mounted along the right horizontal track.

10. The chiropractic table headpiece as claimed in claim 9 comprises:
a second lock;
the second lock comprises a shaft, a lock-receiving hole, a clevis, a head, a stopper, and a cam-locking handle;
the lock-receiving hole traversing normal through the second tab;
the shaft being slidably engaged through the lock-receiving hole and through the right horizontal track;
the head being positioned adjacent to a second surface of the base plate;
the stopper being positioned adjacent to the second tab;
the head being terminally connected to the shaft;
the stopper being slidably connected along the shaft, offset from the head; and,
the cam-locking handle being terminally and pivotally connected to the shaft, opposite the head.

11. The chiropractic table headpiece as claimed in claim 1 comprises:
a plurality of degree markers;
the plurality of degree markers being inscribed into the first surface of the base plate;
the plurality of degree markers being positioned opposite the lower elongated headrest;
the plurality of degree markers being radially distributed about a curved distal edge of the base plate; and,
the plurality of degree markers being centrally aligned with a sagittal plane of the base plate.
